(19) United States
(12) Patent Application Publication
(10) Pub. No.: US 2025/0086361 A1
(43) Pub. Date: Mar. 13, 2025

(54) ID+/ML GUIDED INDUSTRIAL DESIGN PROCESS

(71) Applicant: Google LLC, Mountain View, CA (US)

(72) Inventors: Hannes Harms, Sausalito, CA (US); Steven Benjamin Goldberg, Los Altos Hills, CA (US); Claude Zellweger, San Francisco, CA (US)

(21) Appl. No.: 18/727,461

(22) PCT Filed: Jan. 11, 2023
(86) PCT No.: PCT/US2023/060486

§ 371 Date: Jul. 9, 2024

Related U.S. Application Data
(60) Provisional application No. 63/266,648, filed on Jan. 11, 2022.

(51) Int. Cl. G06F 30/27; G06F 30/10; G06F 111/04

(52) U.S. Cl. CPC G06F 30/27; G06F 30/10; G06F 2111/04

(57) ABSTRACT

A method including receiving a plurality of characteristics associated with an object, receiving a quantity of groups of the object, generating N-dimensional clusters based on the plurality of characteristics and the quantity of groups of the object, receiving a product constraint, and generating data representing a product based on each of the N-dimensional clusters and the product constraint.

### CROSS-REFERENCE TO RELATED APPLICATION

This application claims priority to U.S. Patent Application No. 63/266,648, filed on Jan. 11, 2022, and entitled “ID+/ML GUIDED INDUSTRIAL DESIGN PROCESS,” the disclosure of which is incorporated by reference herein in its entirety.

### FIELD

Implementations relate to product design using a machine-learning guided generative design process.

### BACKGROUND

A product's visual appeal can be an important requirement in the success of the product. Mass customization and personal preferences can lead to the inclusion of a large quantity of appealing product offerings. Designing and maintaining an inventory of the products can be a difficult task. For example, manufacturers in the fashion industry typically can design and keep an inventory of a large number of products including shirts, blouses, pants, scarfs, sunglasses, prescription glasses, and/or the like. Designers can create alternatives of a product to appeal to varying audiences.

### SUMMARY

Example implementations describe using machine learning tools (e.g., models) to aid in the design of a product(s). The machine learning tools can be used to reduce the amount of time involved in designing the product(s). For example, an augmented design process that can include the use of machine learning to analyze a large range of ergonomic data to generate accumulative learnings leading to a number of preferred designs for the product. A designer can be presented with a series of frameworks generated using machine learning tools. The designer may then select and design around this optimized framework to achieve the design with the broadest appeal.

In a general aspect, a method including receiving a plurality of characteristics associated with an object, receiving a quantity of groups of the object, generating N-dimensional clusters based on the plurality of characteristics and the quantity of groups of the object, receiving a product constraint, and generating data representing a product based on each of the N-dimensional clusters and the product constraint.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations and wherein:

FIG. 1 illustrates a block diagram of a data flow for generating a product design according to an example implementation.

FIG. 2 illustrates a block diagram of a data flow for training networks according to an example implementation.

FIG. 3 illustrates a block diagram of a method for generating a product design according to an example implementation.

FIG. 4 illustrates a block diagram of a method for training networks according to an example implementation.

FIG. 5 illustrates a computer system according to an example implementation.

FIG. 6 shows an example of a computer device and a mobile computer device according to at least one example implementation.

FIG. 7 illustrates a data graph according to an example implementation.

It should be noted that these Figures are intended to illustrate the general characteristics of methods, structure and/or materials utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Designing inclusive products can require a lot of contextual awareness. Creating a product (e.g., eyewear products, clothing, headwear, furniture, watch, earbuds, etc.) that looks appealing and meets fit and comfort for a diverse range of users can be complex. For example, a goal can be to design a series of eyewear products that look appealing and fit comfortably on as many people as possible. For example, a goal can be to design a series of wearable computing products (e.g., watches, earbuds, smart glasses, and the like) that look appealing and fit comfortably on as many people as possible. But there is a tradeoff between the number of designs in the series (to appeal to the largest number of potential purchasers) and manufacturing costs (which increase with the number of alternate designs). No tool currently exists for identifying a designated number of designs that will have the broadest appeal. To address this technical problem, disclosed implementations include an augmented design process that can include the use of machine learning to analyze a large range of ergonomic data to generate accumulative learnings leading to a number of preferred designs for the product. A designer can be presented with a series of frameworks generated using machine learning tools. The designer would then select and design around this optimized framework to achieve the design with the broadest appeal.

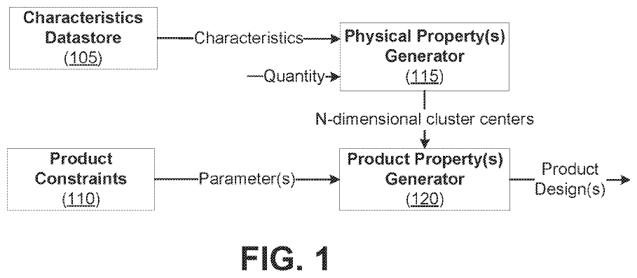

FIG. 1 illustrates a block diagram of a data flow for generating a product design according to an example implementation. As shown in FIG. 1, the data flow includes a characteristics datastore 105 block, a product constraints 110 block, a physical property(s) generator 115 block, and a product property(s) generator 120 block.

The characteristics datastore 105 can be a data structure configured to store and organize characteristics of objects and relationships between the characteristics of an object. In an example implementation, the characteristics datastore 105 can be a structured matrix (e.g., a design structure matrix (DSM)). A structured matrix can represent a large number of elements, objects, characteristics, properties, and the like and their relationships that highlights patterns in the data. The structured matrix can be binary and/or square and can include a label of a characteristic as a row heading and as a column heading. For example, a structured matrix or (e.g., representing the characteristic(s) of an object) corresponding to a head can include a named characteristic representing head shape, eye shape, eye distance, hair line, chin type, nose type, and/or the like. Accordingly, the example structured matrix can include a label for a plurality of each of head shape, eye shape, eye distance, hair line, chin type, nose type, and/or the like in both the column and the row of the structured matrix. Each analyzed head can have an associated matrix. A link between characteristics marked, otherwise, the link can be left empty (or marked differently than if there is a link).

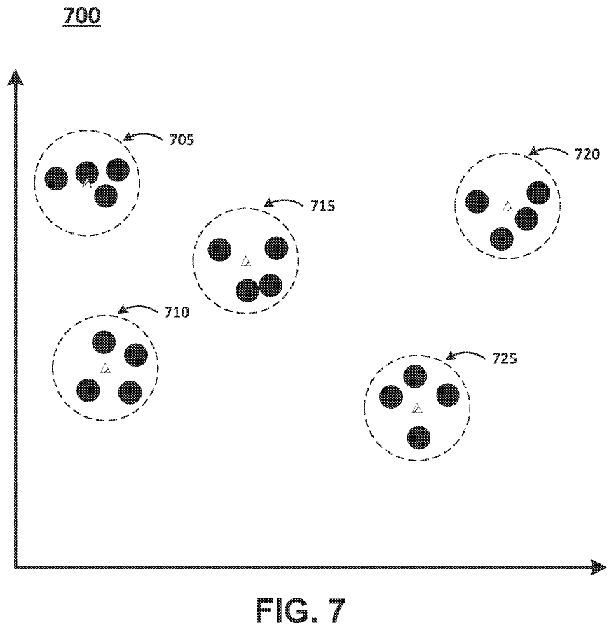

In an example implementation, the characteristics datastore 105 can be a data graph including a plurality of nodes. For example, referring to FIG. 7, a data graph 700 includes a plurality of nodes (illustrated as black dots). In an example implementation, the nodes can include a head identification and a named characteristic(s). The named characteristics can represent head shape, eye shape, eye distance, hair line, chin type, nose type, and/or the like. Every head that is identified as including one of the named characteristics can include an edge to the node representing the named characteristic. Other (known or future techniques) implementations of the characteristics datastore 105 configured to organize characteristics and relationships between characteristics are within the scope of this disclosure, such as a relational database, object-oriented (e.g., JSON) datastore, etc.

The product constraints 110 can be parameter(s) configured to limit product options and configurations. For example, a color could be restricted to blue, a pattern could be limited to checkered, a shape could be limited to rectangular, a material could be limited to plastic, and/or the like. Continuing the eyewear example, the product constraints 110 could be the material is plastic, straight arms, clear lens, incorporated nose piece, and/or the like. The constraints can include minimum and maximum dimensions for one or more of the product elements.

The physical property(s) generator 115 can be configured to generate target physical properties describing a given quantity of groups of objects that use a product. In other words, the target physical properties can identify features of a portion of a body on which the product can be used. For example, target physical properties of a head can be generated for a product (e.g., a hat, eyewear, and the like) that can be used on the head. The target physical properties of the object can be generated using the characteristics datastore 105. For example, characteristics of objects in the characteristics datastore 105 can be selected and/or used to calculate the physical properties (e.g., a pupil-to-cheek measurement, a nose-to-ear measurement, etc.). These physical properties can be organized into the given quantity of clusters and a cluster center determined. For example, referring to FIG. 7, there are five (5) clusters 705, 710, 715, 720, 725 each with a cluster center (illustrated as a triangle). The clusters (e.g., clusters 705, 710, 715, 720, 725) can represent target physical properties for that group of objects. The cluster can thus define the physical properties (e.g., representing a head) associated with a use of the product. The given quantity can be the number of form factors (e.g., different product variations) desired for a product.

Referring to FIG. 7, a data graph 700 includes a plurality of nodes (illustrated as black dots). Each node can represent a characteristic(s), a property(s), a physical property(s), and the like (as described above). The clusters 705, 710, 715, 720, 725 can represent a group. The clusters 705, 710, 715, 720, 725 can represent characteristic(s) and/or properties of a product. In an example implementation, the clusters 705, 710, 715, 720, 725 can represent target physical properties for a group when a cluster(s) is generated using the techniques described herein. In an example implementation, a cluster 705, 710, 715, 720, 725 can represent a product (e.g., a commercial product, a wearable product, and the like). In an example implementation, a cluster 705, 710, 715, 720, 725 can represent an object or portion of a product and/or a configuration of an object or portion where two or more clusters 705, 710, 715, 720, 725 can represent a product. In some implementations, there can be a large number of characteristic(s), a property(s), a physical property(s), and the like. Therefore, it is likely that some characteristic(s), a property(s), a physical property(s), and the like are correlated. Hence, clusters might exist in arbitrarily oriented affine subspaces. These arbitrarily oriented affine subspaces can lead to multi-dimensional clusters or N-dimensional clusters.

Referring back to FIG. 1, if the characteristics datastore 105 is a structured matrix (e.g., a design structure matrix (DSM)), clustering can be accomplished when the matrices are combined, and elements of the matrix are rearranged to form groups or clusters. The groups or clusters can comply with a clustering rule, for example, a maximum number of links within the clusters and minimum outside them. In an example implementation, clustering can be accomplished using a self-organizing neural network (SONN). The SONN can be used for the clustering of multidimensional data. Other existing and future clustering neural networks are within the scope of this disclosure. The layout of a SONN can include an input layer, a competitive layer and an output layer. Each node of the input layer can be a n-dimensional characteristic (or data) vector (v). Each node of the competitive layer can be a neuron. The number of neurons can be equal to the desired clusters (e.g., quantity) to be produced. The single node of the output layer can be the cluster each element of the input layer belongs to. Each neuron of the competitive layer can include weights (w). The weights can be vectors of the same dimension as the input characteristic (or data) vectors. The distance between vi and wⱼ is the main criterion of the jₜₕ neuron for selecting or not, the iₜₕ element for the jₜₕ cluster.

Each neuron of the competitive layer can include biases (b). The bias can be configured to either cause or prevent the elements from being grouped in certain clusters. The bias can be configured to secure the formation of a predefined clusters' number of about the same number of elements. Therefore, the absence of bias can cause the network to form fewer clusters than the desired number and in a different magnitude. Each neuron of the competitive layer can include a distance function (DIST) configured to calculate a Euclidian distance between vᵢ and wⱼ. Each neuron of the competitive layer can include a summing function configured to add the distance to the bias. Each neuron of the competitive layer can include a competitive transfer function (C) configured to determine whether or not the iₜₕ element will belong to the jₜₕ cluster.

During execution of the network, the input v can enter one after the other such that the neurons and the Euclidean distance between vᵢ and wⱼ is calculated. Then, this calculated distance is added to the bias of the neuron in the summing function. Finally, the sum enters the competitive function (C), which determines whether or not the vᵢ is going to be clustered into the certain cluster-neuron. The initial value given to the weights occurs from the midpoint function (places the weights in the middle of the input ranges). After the completion of each run, the network provides a clustering result.

If the characteristics datastore 105 is a data graph, a JSON datastore, or a relational database, clustering can be accomplished by rearranging the data graph to form groups or clusters. For example, any clustering algorithm can be used, such as k-means clustering. The clustering algorithm would segment the group of objects into groups (clusters) based on a characteristic vector description (e.g., a feature vector describing the physical properties of an object) for each object. Once the clusters are obtained, different metrics are obtained for each cluster. These different metrics can include cluster size and/or cluster compactness. Cluster size determines how many objects are included in that particular cluster. Cluster compactness determines how spread the physical properties in that cluster are. The more spread is the cluster, the more likely that there would be errors within that cluster. Metrics such as cluster size and compactness may be used to choose cluster centers. A combination of these metrics can also be used. Other (known or future techniques) implementations of clustering are within the scope of this disclosure.

The product property(s) generator 120 can be configured to generate a product design customized to a cluster generated by the physical property(s) generator 115. The product property(s) generator 120 can be a trained machine learned network (sometimes called a model). The generated product property(s) 120 can be a generative design model, e.g., a generative adversarial network (GAN), configured to generate a product design that can be used to make the corresponding product. Because the product property(s) generator 120 uses the cluster center properties as input, the product property(s) generator 120 can be trained to generate a framework for an aesthetically pleasing design, e.g., optimized for the target physical properties of a cluster. In an example implementation, the target physical properties can be modified (e.g., using human intervention design techniques) to generate a final design and/or design for manufacture. In an example implementation, the target physical properties are modified (e.g., using human intervention design techniques) to generate a final design and/or design for manufacture. In other words, the target physical properties can be used by a human designer as a basis for a final design.

Continuing the eyewear example, the product property(s) generator 120 can generate an eyewear product design for a cluster representing a head. The generated eyewear product design can represent eyewear that is aesthetically pleasing and of a fashion that fits the head represented by the cluster based on the product constraints 110. In an example implementation, the eyewear product design would be modified (e.g., using human intervention design techniques) to generate a final eyewear product design and/or eyewear product design for manufacture.

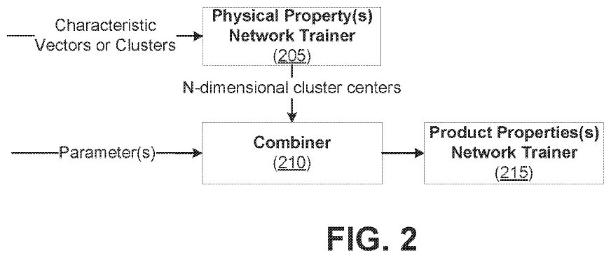

FIG. 2 illustrates a block diagram of a data flow for training networks according to an example implementation. As shown in FIG. 2, the data flow includes a physical property(s) network trainer 205 block, a combiner 210 block, and a product property(s) network trainer 215 block.

The physical property(s) network trainer 205 can be configured to train a neural network used for clustering data. For example, the physical property(s) network trainer 205 can be configured to train the above described SONN. The SONN can be trained using unsupervised competitive learning with DSM representations (e.g., simulated or stored DSM representations). Training the SONN can include iterating (one (1) iteration is sometimes called an epoch) the procedure described above. At each iteration, the weights are updated based on a learning rule (e.g., the Kohonen learning rule) and the biases. A learning function can be used to grow (e.g., increase a value) the bias disproportionally to the percentage of the successes (e.g., acceptable clusters) that a neuron accomplishes. The SONN can be trained using a hybrid supervised-unsupervised algorithm. For example, an initial set of DSM data can be labeled, and the weights can be adjusted based on a comparison to the label in a supervised manner followed by the unsupervised training described above.

The combiner 210 can be configured to combine parameter(s) based on constraint(s) with the N-dimensional cluster centers generated by the physical property(s) network trainer 205 (or clusters input as training data). Combining parameters can use a generator network to transform the parameter(s) into a meaningful output. Combining parameters can include using a discriminator network (e.g., a trained discriminator network) to modify the meaningful output based on constraint(s). In an example implementation, the meaningful output can describe a product (e.g., eyewear). In an example implementation, the parameter(s) can be combined with the N-dimensional cluster centers to generate characteristic vectors to be used as input to the product property(s) network trainer 215. The results of the combiner 210 can be a vector (e.g., characteristic vector) of clusters each having a corresponding set of parameter(s) that can be used to test (in the training process) whether or not the combination results in an aesthetically pleasing product (e.g., eyewear).

The product property(s) network trainer 215 can be configured as a training module configured to generate a loss (e.g., using a loss algorithm) representing how aesthetically pleasing a product generated (or predicted) using the N-dimensional cluster centers combined with the parameter(s) may be. The training of the product property(s) network 215 can include modifying weights associated with, for example, a convolution neural network (CNN). In an example implementation, product property(s) network trainer 215 can be trained based on a difference between a predicted product and a ground truth product (e.g., an aesthetically pleasing product, a pre-determined aesthetically pleasing product, and the like). A loss can be generated based on the difference between the predicted product and the ground truth product. The loss algorithm can be a squared loss, a mean squared error loss, and/or the like. Training iterations can continue until the loss is minimized and/or until the loss does not change significantly from iteration to iteration. In an example implementation, the lower the loss, the more aesthetically pleasing the product may be. unsupervised competitive learning, as described above, and/or a hybrid supervised-unsupervised algorithm can also be used.

In an example implementation, the combiner 210 and the product property(s) network trainer 215 can be elements of a generative adversarial network (GAN). For example, the combiner 210 can be a generator network and the product property(s) network trainer 215 can be a discriminator network. The training of the GAN can take several examples of N-dimensional cluster centers, parameters (e.g., constraints), and real product designs (e.g., designated as one of “looks good” and “looks bad” as input). The discriminator may be trained with the labeled data to correctly predict good or bad designs. The discriminator may then be used to train the generator network, e.g., to produce more designs that look good than look bad, until the network figures out how to generally create what “looks good” without creating what “looks bad” from the input. Thus, in general, the generator network (e.g., the product property(s) network trainer 215) can receive an N-dimensional cluster and the parameters and generate a product design, and the discriminator can determine whether the generator network generated the correct output.

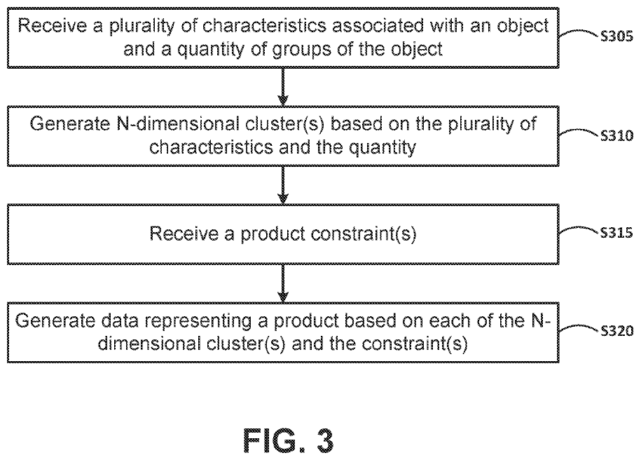

Example 1. FIG. 3 illustrates a block diagram of a method for generating a product design according to an example implementation. As shown in FIG. 3, in step S305 the method includes receiving a plurality of characteristics associated with an object. In step S310 the method includes receiving a quantity of groups of the object. In an example implementation, the receiving of the plurality of characteristics associated with the object can include reading (e.g., executing a computer instruction to read) from the plurality of characteristics from a characteristics datastore (e.g., the characteristics datastore 105). In an example implementation, the object can be a portion of a commercial product (e.g., smart glasses). Therefore, the plurality of characteristics can be characteristics of the commercial product (e.g., material, lens size, lens shape, frame style, and the like).

In step S315 the method includes generating N-dimensional clusters based on the plurality of characteristics and the quantity of groups of the object. In step S320 the method includes receiving a product constraint. In step S325 the method includes generating data representing a product based on each of the N-dimensional clusters and the product constraint. In an example implementation, the product can be a commercial product (e.g., a product for sale) including, for example wearable products or products that are wearable on a body part and/or portion of a body part. In an example implementation, a product specification can be generated for each cluster. In an example implementation, the product specification includes target physical properties that can be modified (e.g., using human intervention design techniques) to generate a final product design and/or product design for manufacture. In other words, the target physical properties can be used by a human designer as a basis for a final product design. In an example implementation, the target physical properties are used by a human designer as a basis for a final product design.

Example 2. The method of Example 1, wherein the plurality of characteristics can include a relationship between two or more of the plurality of characteristics.

Example 3. The method of Example 1, wherein the plurality of characteristics can be stored as a matrix or a data graph.

Example 4. The method of Example 3, wherein the plurality of characteristics can be stored as the matrix, and elements of the matrix can be rearranged to form the N-dimensional clusters.

Example 5. The method of Example 3, wherein the plurality of characteristics can be stored as the matrix, and the N-dimensional clusters can be generated using a self-organizing neural network.

Example 6. The method of Example 3, wherein the plurality of characteristics can be stored as the data graph, and the N-dimensional clusters can be generated by rearranging the data graph.

Example 7. The method of Example 1, wherein the product constraint can be configured to limit an option and/or a configuration of the product.

Example 8. The method of Example 1 can further include generating a target physical property indicating the quantity of groups of the object as used in the product.

Example 9. The method of Example 8, wherein the target physical property can identify features of a portion of a body on which the product can be used.

Example 10. The method of Example 8, wherein the target physical property can be generated based on the plurality of characteristics associated with the object.

Example 11. The method of Example 8 can further include receiving edits to the target physical property prior to generating the data representing the product.

Example 12. The method of Example 1, wherein generating the data can include providing the N-dimensional clusters as input to a generative design model, which produces the data representing the product as output.

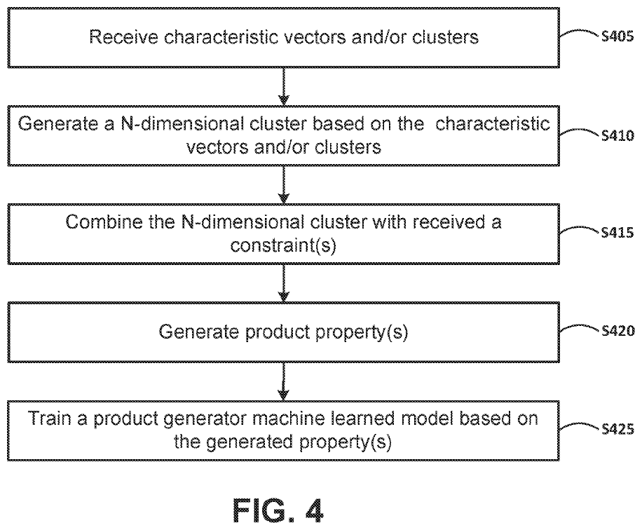

Example 13. FIG. 4 illustrates a block diagram of a method for training networks according to an example implementation. As shown in FIG. 4, in step S405 the method includes receiving characteristic vectors and/or clusters. In step S410 the method includes generating an N-dimensional cluster based on the characteristic vectors and/or clusters. In step S415 the method includes receiving a product constraint and combining the N-dimensional cluster with the product constraint. In step S420 the method includes generating a property associated with a product. In step S425 the method includes training a product generator machine learning model based on the property associated with the product.

Example 14. The method of Example 13, wherein the N-dimensional cluster can be generated using a self-organizing neural network (SONN), and the training of the product generator machine learning model can include training the SONN. The SONN can include an input layer, a competitive layer and an output layer. Each node of the input layer can be a n-dimensional characteristic (or data) vector (v). Each node of the competitive layer can be a neuron. The number of neurons can be equal to the desired clusters (e.g., quantity) to be produced. The single node of the output layer can be the cluster each element of the input layer belongs to. The input layer, the competitive layer and the output layer can be trained independently and/or together in any combination.

Example 15. The method of Example 14, wherein the SONN can be trained using unsupervised competitive learning with design structure matrix representations.

Example 16. The method of Example 13, wherein the training of the product generator machine learning model can include disproportionally increasing a bias.

Example 17. The method of Example 13, wherein the combining of the N-dimensional cluster with the product constraint can include combining centers of the N-dimensional cluster with the product constraint to generate vectors. For example, centers of the N-dimensional cluster can represent an element of a product. Combining the centers based on the product constraint can represent selecting elements of the product to generate a complete product. In some implementations, two or more centers can represent an element. Therefore, two or more product designs can be generated using the combining process.

Example 18. The method of Example 13, wherein the training of the product generator machine learning model can include generate a loss representing how aesthetically pleasing a generated product is. Training can include a supervised training step. Supervised training includes some human interaction using, for example, labelled data. labelled data can be ground truth data Therefore, aesthetically pleasing can be implemented through use of supervised training.

Example 19. The method of Example 13, wherein the product generator machine learning model is trained based on a difference between a predicted product and a ground truth product. A ground truth product can be a pre-determined aesthetically pleasing product.

Example 20. The method of Example 13, wherein the machine learning model can be configured to generate an element(s) representing a portion of a product based on an input property.

Example 21. A method can include any combination of one or more of Example 1 to Example 20.

Example 22. A non-transitory computer-readable storage medium comprising instructions stored thereon that, when executed by at least one processor, are configured to cause a computing system to perform the method of any of Examples 1-21.

Example 23. An apparatus comprising means for performing the method of any of Examples 1-21.

Example 24. An apparatus comprising at least one processor and at least one memory including computer program code, the at least one memory and the computer program code configured to, with the at least one processor, cause the apparatus at least to perform the method of any of Examples 1-20.

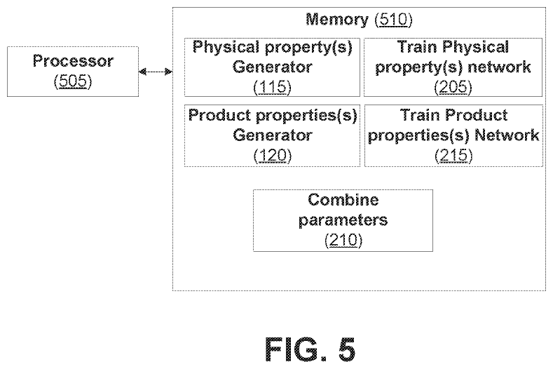

FIG. 5 illustrates a computer system according to an example implementation. As shown in FIG. 5, a device includes a processor 505, and a memory 510. The memory 510 includes the physical property(s) generator 115, the product property(s) generator 120, the physical property(s) network trainer 205, the combiner 210, and the product property(s) network trainer 215.

In the example of FIG. 5, the device can include a computing system or at least one computing device and should be understood to represent virtually any computing device configured to perform the techniques described herein. As such, the device may be understood to include various components which may be utilized to implement the techniques described herein, or different or future versions thereof. By way of example, device is illustrated as including processor 505 (e.g., at least one processor), as well as at least one memory 510 (e.g., a non-transitory computer readable storage medium).

The processor 505 may be utilized to execute instructions stored on the at least one memory 510. Therefore, the processor 505 can implement the various features and functions described herein, or additional or alternative features and functions. The processor 505 and the at least one memory 510 may be utilized for various other purposes. For example, the at least one memory 510 may represent an example of various types of memory and related hardware and software which may be used to implement any one of the modules described herein.

The at least one memory 510 may be configured to store data and/or information associated with the device. The at least one memory 510 may be a shared resource. Therefore, the at least one memory 510 may be configured to store data and/or information associated with other elements (e.g., wired/wireless communication) within the larger system. Together, the processor 505 and the at least one memory 510 may be utilized to implement the physical property(s) generator 115, the product property(s) generator 120, the physical property(s) network trainer 205, the combiner 210, and the product property(s) network trainer 215.

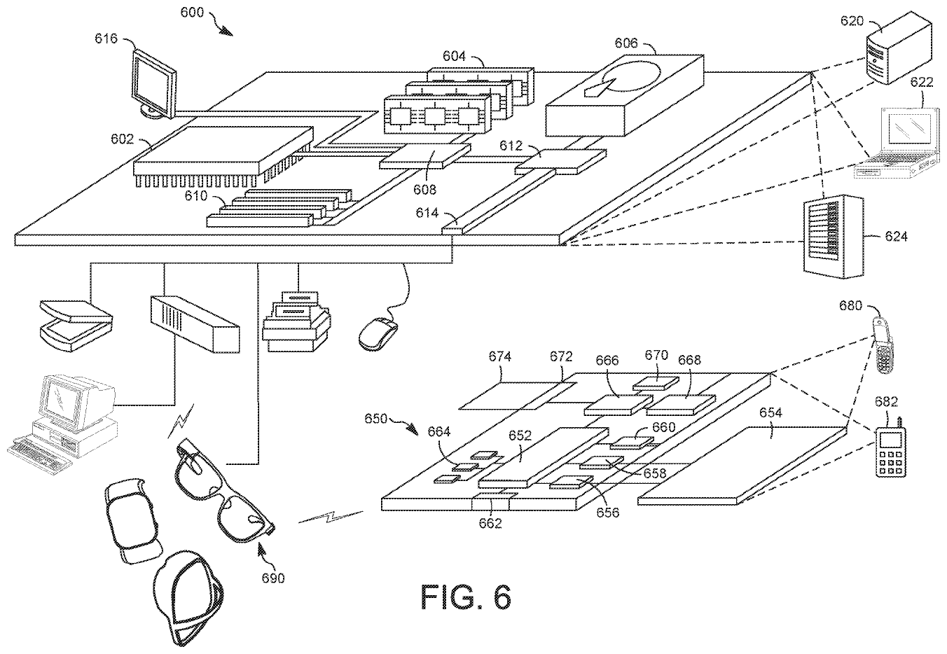

FIG. 6 illustrates an example of a computer device 600 and a mobile computer device 650, which may be used with the techniques described here (e.g., to implement the physical property(s) generator 115, the product property(s) generator 120, the physical property(s) network trainer 205, the combiner 210, and the product property(s) network trainer 215. The computing device 600 includes a processor 602, memory 604, a storage device 606, a high-speed interface 608 connecting to memory 604 and high-speed expansion ports 610, and a low-speed interface 612 connecting to low-speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high-speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high-speed controller 608 manages bandwidth-intensive operations for the computing device 600, while the low-speed controller 612 manages lower bandwidth-intensive operations. Such allocation of functions is example only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display), and LED (Light Emitting Diode) or an OLED (Organic Light Emitting Diode) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In-Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, Wi-Fi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the figure can include sensors that interface with an AR headset/HMD device 690 to generate an augmented environment for viewing inserted content within the physical space. For example, one or more sensors included on a computing device 650 or other computing device depicted in the figure, can provide input to the AR headset 690 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 650 can use the sensors to determine an absolute position and/or a detected rotation of the computing device in the AR space that can then be used as input to the AR space. For example, the computing device 650 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 650 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 650 when the computing device is incorporated into the AR space can cause a particular action to occur in the AR space.

In some implementations, a touchscreen of the computing device 650 can be rendered as a touchpad in AR space. A user can interact with the touchscreen of the computing device 650. The interactions are rendered, in AR headset 690 for example, as movements on the rendered touchpad in the AR space. The rendered movements can control virtual objects in the AR space.

In some implementations, one or more output devices included on the computing device 650 can provide output and/or feedback to a user of the AR headset 690 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 650 may appear as another object in a computer-generated, 3D environment. Interactions by the user with the computing device 650 (e.g., rotating, shaking, touching a touchscreen, swiping a finger across a touch screen) can be interpreted as interactions with the object in the AR space. In the example of the laser pointer in an AR space, the computing device 650 appears as a virtual laser pointer in the computer-generated, 3D environment. As the user manipulates the computing device 650, the user in the AR space sees movement of the laser pointer. The user receives feedback from interactions with the computing device 650 in the AR environment on the computing device 650 or on the AR headset 690. The user's interactions with the computing device may be translated to interactions with a user interface generated in the AR environment for a controllable device.

In some implementations, a computing device 650 may include a touchscreen. For example, a user can interact with the touchscreen to interact with a user interface for a controllable device. For example, the touchscreen may include user interface elements such as sliders that can control properties of the controllable device.

Computing device 600 is intended to represent various forms of digital computers and devices, including, but not limited to laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

1. A method comprising:
receiving a plurality of characteristics associated with an object;
receiving a quantity of groups of the object;
generating N-dimensional clusters based on the plurality of characteristics and the quantity of groups of the object;
receiving a product constraint; and
generating data representing a product based on each of the N-dimensional clusters and the product constraint.

2. The method of claim 1, wherein the plurality of characteristics include a relationship between two or more of the plurality of characteristics.

3. The method of claim 1, wherein the plurality of characteristics are stored as a matrix or a data graph.

4. The method of claim 3, wherein
the plurality of characteristics are stored as the matrix, and
elements of the matrix are rearranged to form the N-dimensional clusters.

5. The method of claim 3, wherein
the plurality of characteristics are stored as the matrix, and
the N-dimensional clusters are generated using a self-organizing neural network.

6. The method of claim 3, wherein
the plurality of characteristics are stored as the data graph, and
the N-dimensional clusters are generated by rearranging the data graph.

7. The method of claim 1, wherein the product constraint is configured to limit at least one of an option or a configuration of the product.

8. The method of claim 1, further comprising generating a target physical property indicating the quantity of groups of the object as used in the product.

9. The method of claim 8, wherein the target physical property identifies features of a portion of a body on which the product is used.

10. The method of claim 8, wherein the target physical property is generated based on the plurality of characteristics associated with the object.

11. The method of claim 8, further comprising receiving edits to the target physical property prior to generating the data representing the product.

12. The method of claim 1, wherein generating the data includes providing the N-dimensional clusters as input to a generative design model, which produces the data representing the product as output.

13. A method comprising:
receiving characteristic vectors;
generating an N-dimensional cluster based on the characteristic vectors;
receiving a product constraint;
combining the N-dimensional cluster with the product constraint;
generating a property associated with a product; and
training a product generator machine learning model based on the property associated with the product.

14. The method of claim 13, wherein
the N-dimensional cluster is generated using a self-organizing neural network (SONN), and
the training of the product generator machine learning model includes training the SONN.

15. The method of claim 14, wherein the SONN is trained using unsupervised competitive learning with design structure matrix representations.

16. The method of claim 13, wherein the training of the product generator machine learning model includes disproportionally increasing a bias.

17. The method of claim 13, wherein the combining of the N-dimensional cluster with the product constraint includes combining centers of the N-dimensional cluster with the product constraint to generate vectors.

18. The method of claim 13, wherein the training of the product generator machine learning model includes generating a loss representing how aesthetically pleasing a generated product is.

19. The method of claim 13, wherein the product generator machine learning model is trained based on a difference between a predicted product and a ground truth product.

20. The method of claim 13, wherein
the product generator machine learning model is configured to generate at least one element representing a portion of a product based on an input property.
